(19) United States
(12) Patent Application Publication
(10) Pub. No.: US 2021/0262272 A1
(43) Pub. Date: Aug. 26, 2021

(54) VEHICLE DOOR SYSTEM

(71) Applicant: Applied Electric Vehicles Pty Ltd, Victoria (AU)

(72) Inventors: Mitchell Penning BESSEL, Loganlea (AU); Matthew Campbell GREAVES, Corinda (AU)

(21) Appl. No.: 17/317,201

(22) Filed: May 11, 2021

Related U.S. Application Data
(63) Continuation-in-part of application No. PCT/AU2019/000143, filed on Nov. 15, 2019.

(30) Foreign Application Priority Data
Nov. 15, 2018 (AU) 2018904352
May 13, 2020 (AU) 2020901534

(51) Int. Cl. E05F 15/56; E05F 15/53; B60J 5/04

(52) U.S. Cl. CPC E05F 15/56; E05F 15/53; B60J 5/0477; E05Y 2201/22; E05Y 2201/41; E05Y 2201/64; E05Y 2201/454; E05Y 2201/624; E05Y 2201/684; E05Y 2900/531; E05Y 2201/422

(57) ABSTRACT

A mechanism to enable opening and closing of a vehicle door comprising a swing arm assembly in use pivotally coupled between a vehicle structure and a slide support carriage. The slide support carriage being mounted to an elongate rail assembly attached to the vehicle door for movement there along. The mechanism further comprises a motion control surface attached to or integral with the door assembly and a follower assembly to regulate relative simultaneous pivotal motion of the swing arm according to the position and motion of the slide support carriage along the rail assembly.

### FIELD

This invention relates to mechanisms and systems for opening and closing vehicle doors. In particular, the invention is described with reference to mechanisms and systems for automated opening and closing of multi-doors on vehicles. A particular embodiment is directed to an autonomous roadway delivery vehicle having multi-doors that are in close proximity to each other.

### BACKGROUND

A door system for a vehicle such as an automotive vehicle is conventionally provided to allow an occupant to enter and exit an occupant compartment through a door opening in the vehicle body. The typical vehicle door is pivotally mounted at a front end by a hinge to vehicle structure and opens outwardly, although other forms of door mounting and movement are also known, such as vertically pivoting and sliding door arrangements. Sliding doors, for example, are advantageous in allowing door operation in a narrow parking space or when the automotive vehicle is parked closely to an object. Moreover, sliding door systems provide improved ingress/egress through the door opening to the occupant compartment of the automotive vehicle.

In a typical sliding door opening and closing structure, a guide rail including a linear portion and a curved portion is incorporated into a vehicle side portion, and the sliding door is guided along the guide rail in an opening or closing direction. To open, the door is projected in a vehicle exterior direction along the curved portion of the guide rail, and then the door is slidably moved to a fully opened position. Conversely, to close the door is moved along the linear portion of the guide rail to the curved portion, and then the door is pulled inward in a vehicle interior direction along the curved portion. However, in this structure the inward and outward moving locus of the door coincides with the curved shape of the guide rail, meaning the guide rail must have a large, curved portion corresponding to the amount of outward projection required for the door. A guide rail of this type can have disadvantageous influences on the vehicle structure. A disadvantage of such door opening and closing structure, is the need to have a guide rail incorporated into the vehicle side portion. Such arrangement could not be employed in a vehicle having a plurality of doors adjacent or in close proximity to each other. This is because the guide rail of the typical sliding door opening and closing structure must be placed in the vehicle side portion immediately adjacent the door, which prohibits the placement of a further door where the guide rail exists.

Swinging and sliding doors for motor vehicles are also known that have a door panel and at least one pivoting arm secured to the wall of the vehicle, with a carriage articulated to the end of the arm, the arm sliding back and forth on a carrier connected to the door panel. Doors of this type are typically opened and closed manually and incorporate guide mechanisms that ensure that the panel will start to open by pivoting out of the doorway, after which it can be slid to a fully open position. An example of this type of mechanism is presented in US2010/0095595 (Hanaki et al.) wherein a cable operated system includes a pivot hinge and slide mechanism that restricts the motion through the use of a slider and a series of stoppers to create a sequential motion of rotation and then translation as the door opens.

However, an opening and closing structure of this prior art having a swing mechanism and slide mechanism provided separately, also presents challenges. To actuate one of the two mechanisms, the other mechanism needs to be locked. Due to this, an opening and closing operation for the slide door becomes a stepped operation, making it disadvantageously difficult to smoothly open and close the slide door. Furthermore, if the door opening and closing operation is to be automated by incorporating an electric motor into this opening and closing structure, it is necessary to incorporate separately controlled electric motors into each of the swing mechanism and the slide mechanism. This disadvantageously complicates the opening and closing structure and the associated control system, as well as impacting on the space and weight considerations.

Automatic sliding doors have been utilised on various kinds of vehicles for many years and are commonplace on public vehicles such as buses and trains. Typically, these mechanisms are heavy and bulky, which is of little consequence for use on a large and heavy vehicle. Sliding style doors are also a common selection for autonomous vehicles as they limit the requirement of sensors to ensure that the doors do not collide with any objects during opening. Nevertheless, door operations on autonomous vehicles present certain challenges that may not be encountered, or be unnecessary to address, in other kinds of vehicles. One of the key requirements is passenger safety and avoidance of passenger harm from the automated operation of the door. Such considerations may take into account the possibility for manual operation of a door, in the event that the autonomous systems should fail or be deactivated.

In consideration of the above, embodiments of the present invention aim to ameliorate a number of deficiencies in prior art door actuation mechanisms, and provide new and improved systems, mechanisms and arrangements to overcome or reduce at least one of the aforementioned disadvantages of known systems.

### SUMMARY

In a first aspect the present invention consists of a mechanism to enable opening and closing of a vehicle door comprising:

a swing arm assembly in use pivotally coupled between a vehicle structure and a slide support carriage;

said slide support carriage being mounted to an elongate rail assembly attached to said vehicle door for movement there along;

wherein said mechanism further comprises a motion control surface attached to or integral with said door assembly and a follower assembly to regulate relative simultaneous pivotal motion of said swing arm according to the position and motion of said slide support carriage along said rail assembly, and a pneumatically operated rotary actuator arranged to drive pivotal motion of said swing arm assembly, and pneumatically operated a linear actuator arranged to drive relative linear motion between said rail assembly and said slide support carriage.

Preferably said pneumatically actuated rotary actuator is attached to the vehicle mounting structure of said mechanism.

Preferably said linear actuator comprises a rod-less cylinder forming part of said elongate rail assembly, together with a magnetically coupled follower incorporated into said slide support carriage.

Preferably said motion control surface and said follower assembly regulate said position of said slide support along said rail assembly according to the pivotal movement of said swing arm according to the shape of said motion control surface.

Preferably said vehicle comprises a plurality of wheels operably controlled by an automated steering control system, and prior to or during a door opening sequence, said wheels are straightened by said automated steering control system.

Preferably said mechanism comprises a two-stage locking device that directly locks said rotary actuator and blocks linear motion of said linear actuator when said vehicle door is in a closed position.

In a second aspect the present invention consists of a system for use in opening and closing a vehicle door comprising:

a door actuation mechanism including:

a swing arm assembly pivotally coupled between a vehicle structure and a slide support carriage;

said slide support carriage being mounted to an elongate rail assembly attached to said vehicle door for movement there along; and

wherein said mechanism further includes a motion control surface attached to or integral with said door assembly and a follower assembly to regulate relative pivotal motion of said swing arm according to the position and motion of said slide support carriage along said rail assembly according to the shape of said motion control surface;

a first pneumatic actuator coupled to drive pivotal motion of said swing arm assembly;

a second pneumatic actuator coupled to drive linear motion of said rail assembly relative to the slide support carriage; and

a control means arranged to operate said first and second pneumatic actuators simultaneously.

Preferably said rotary actuator is attached to the vehicle mounting structure of said mechanism.

Preferably said second pneumatic actuator comprises a rod-less cylinder forming part of said elongate rail assembly, together with a magnetically coupled follower incorporated into said slide support carriage.

In a third aspect the present invention consists of a door assembly for a vehicle having a structure defining an access aperture, said door assembly comprising:

a door movable between a closed position covering at least a portion of said aperture and an open position substantially clearing at least said portion of said aperture;

a door actuation mechanism coupling said door to said structure, said door actuation mechanism including:

a swing arm assembly mounted to said structure adjacent said aperture and pivotally coupled to a slide support carriage, said slide support carriage mounted to an elongate rail assembly attached to said door for movement there along, wherein said door actuation mechanism includes a motion control surface to regulate simultaneous pivotal motion of said swing arm according to the position and motion of said slide support carriage along said rail assembly;

a first pneumatic actuator coupled to drive pivotal motion of said swing arm assembly;

a second pneumatic actuator coupled to drive linear motion of said rail assembly relative to said slide support carriage; and

a control means arranged to operate said first and second pneumatic actuators.

Preferably said first pneumatic actuator is attached to the vehicle mounting structure of said mechanism.

In a fourth aspect the present invention consists of a roadway vehicle comprising: a vehicle body structure defining an access aperture;

a door assembly including a door movable between a closed position covering at least a portion of said aperture and an open position substantially clearing at least said portion of the aperture;

a door actuation mechanism coupling said door to said vehicle body structure, said door actuation mechanism including:

a swing arm assembly mounted to said vehicle body structure adjacent said aperture and pivotally coupled to a slide support carriage, said slide support carriage being mounted to an elongate rail assembly attached to said door for movement there along, wherein said door actuation mechanism includes a motion control surface attached to integral with said door assembly and a follower assembly to regulate relative pivotal motion of said swing arm according to the position and motion of said slide support carriage along said rail assembly;

a first pneumatic actuator coupled to drive pivotal motion of said swing arm assembly;

a second pneumatic actuator coupled to drive linear motion of said rail assembly relative to said slide support carriage; and

a control means arranged to operate said first and second pneumatic actuators simultaneously.

Preferably said first pneumatic actuator is attached to the vehicle mounting structure of said mechanism.

In a sixth aspect the present invention consists of a roadway vehicle comprising:

a vehicle body structure defining at least first and second access apertures, said first and second access apertures being adjacent to each other on the same side of said vehicle body structure; each of said first and second access apertures having a respective first and second door assembly;

said first door assembly including a first door movable between a closed position covering at least a portion of said first access aperture and an open position substantially clearing at least said portion of said first access aperture;

a door actuation mechanism coupling said first door to said vehicle body structure, said door actuation mechanism including:

a swing arm assembly mounted to said vehicle body structure adjacent said first access aperture and pivotally coupled to a slide support carriage, said slide support carriage being mounted to an elongate rail assembly attached to said first door for movement there along, wherein said door actuation mechanism includes a motion control surface attached to integral with said first door assembly and a follower assembly to regulate relative pivotal motion of said swing arm according to the position and motion of said slide support carriage along said rail assembly;

a first pneumatic actuator coupled to drive pivotal motion of said swing arm assembly;

a second pneumatic actuator coupled to drive linear motion of said rail assembly relative to said slide support carriage; and

a control means arranged to operate said first and second pneumatic actuators simultaneously.

Preferably said second pneumatic actuator, comprises a rod-less cylinder forming part of said elongate rail assembly, together with a magnetically coupled follower incorporated into said slide support carriage.

Preferably said second door assembly including a second door movable between a closed position covering at least a portion of said second access aperture and an open position substantially clearing at least said portion of said second access aperture is disposed adjacent the first access aperture, and said second door is coupled to said vehicle body structure with a like actuation mechanism to that of said first door.

Preferably said roadway vehicle is a cargo delivery vehicle.

Preferably said roadway vehicle is an autonomous vehicle.

Preferably said first and second access apertures are side by side to each other.

Preferably said first and second access apertures are disposed one of above the other.

Preferably said vehicle comprises a plurality of wheels operably controlled by an automated steering control system, and prior to or during a door opening sequence, said wheels are straightened by said automated steering control system.

The term “slide” and related terminology, where used in this specification (unless the context clearly requires otherwise), generally refers to relative movement between two components, typically guided movement along a defined path, although the movement may be assisted by bearings or the like and use of the term does not connote a frictional engagement between the components.

Embodiments of the invention provide a pneumatically actuated automatic vehicle door opening and closing mechanism, particularly suited for use on a lightweight autonomous vehicle. The mechanism may be fitted to allow for the front doors to travel forward and rear doors to travel rearwards in a sliding movement near parallel to the outside of the vehicle.

In embodiments the door opening and closing mechanism includes a rotary actuator, linear actuator, linear guide, swing arm hinge, motion guide, latching mechanism and control system. Although the mechanism is predominantly described herein in the context of automatic pneumatically powered operation, it may also operate as a manual mechanism or semi-manual with the addition of a gas strut/spring actuation, for example.

The door opening and closing mechanism according to embodiments allows the door to initially rotate slightly as the movement begins, as this action aids in the release of the door seal and the release of any mating features between the front and rear doors. In use the door then moves primarily outwards, substantially perpendicular to the axis of the vehicle, until the door clears the side of the vehicle at which point the mechanism is arranged to allow the door to begin forward translation (or rearwards for a rear door). The rotation of the door transforms smoothly into a pure translation until the door reaches its fully open position.

In embodiments the path of motion is provided by a combination of a near-parallel four-bar linkage swing arm arrangement and a linear slide. In use rotational movement of the swing arm may be affected by a rotary actuator, with linear movement effected by a linear actuator. The combination of rotation and translation is controlled by a novel motion control surface which may have a follower device integrated into one pivoting link of the swing arm assembly. This motion control surface may in one embodiment comprise a bearing travelling on a cam surface. The shape of the cam surface is adapted to control the relative combination of hinge rotation and linear translation. In the closed configuration of the mechanism the cam surface is arranged to limit the translation of the door and in the open configuration the combination is able to limit the rotation of the door. This enables the mechanism to ensure that the door will not travel in motion that could causes a collision of the door with the exterior of the vehicle, regardless of the control input.

The near-parallel linkage swing arm geometry can be adapted to suit various door trajectories through the designed placement of the pivot points and selected relative lengths of the pivoting link members. The swing arm arrangement provides a stiff hinge structure with control over the parallelism of the door relative to the vehicle throughout the travel. Advantageously, fine adjustment of one of the swing arm pivot points can easily be made to alter the final seated position of the door, in use. This allows for tolerances in construction of the vehicle and door mechanism. For example, a forward inner link member pivot point can be adjusted fore/aft to control the door rest position inwards and outwards, and conversely adjustment of the mount point inwards and outwards may be used to control the fore/aft rest position of the door.

The linear slide of the mechanism could take many forms, and in one embodiment the slide includes a hardened steel linear rail with a recirculating ball cartridge unit. Another novel aspect of the door opening/closing mechanism according to embodiments of the invention is that the linear action may be provided by a magnetically coupled rod-less pneumatic actuator. This provides a lightweight and extremely compact actuator which can translate a relatively high proportion of the actuator's overall length, which is beneficial to implementation of the invention in use. Another feature of this actuator is the added safety of the magnetic coupling which provides an absolute limit to the actuator force.

As outlined above, the relative motion of the rotation of the swing arm and linear motion of the slide is control by the novel motion control surface. Operation of the follower on the control surface means that the door opening and closing sequence is inherent in the mechanical arrangement and may be determined by design of the cam surface. In one embodiment of the invention the motion control surface comprises a bearing mounted to an extension of the secondary swing arm assembly link and formed as a single component. In another embodiment the bearing could be replaced by a hardened sliding cam surface which could also be formed as part of or added to the swing arm link. In another embodiment this element could be replaced by a pin which travels in a curved slot to act as the cam surface.

When embodiments of the invention are implemented in a vehicle, the mechanism may typically be almost entirely hidden within a set of covers, however the design is well suited to forming a ‘clean’ set of surfaces to such an extent that the components making it up could be considered to be visually appealing. In an exposed mechanism design the linear slide may form a handrail and elbow rest, for example. The linear slide may also be adapted to act as a functional member in the vehicle structure, for example for the purposes of rigidity in the event of a collision. In such application the linear slide may be constructed from stiff, hardened components/materials that provide intrusion protection to the vehicle occupants. Where the vehicle body has a centre column between the front and rear doors the linear slide may thus engage securely with the centre column when the door is closed otherwise, for a pillar-less structure the front and rear door linear slide components may be arranged to interlock with one another when in a closed configuration in order to provide sufficient protection against side intrusion.

One significant feature of the novel design is that control of the actuator is inherently simple. For example, in embodiments the mechanism may comprise part of a system wherein selected pneumatic pressure can be simultaneously applied to both the rotary and linear actuators and the sequencing of the relative motion will be inherently controlled by the door mechanism and its motion control surface. Alternatively, each actuator can be supplied with different pressures concurrently through the use of additional pressure regulating devices. Safety aspects of the system can be ensured by maintaining a low differential pressure across the linear actuator until the door seal is required to be compressed, wherein additional force may be required. In other embodiments additional force to compress the seal and assist in holding the door closed could be provided by a separate set of door clamping mechanisms.

A system incorporating the door mechanism may include a sensor fitted to the door or vehicle to continuously monitor the door position during opening/closing, if desired. Alternatively, a simple end of travel sensor can be utilised. In other possible embodiments a position monitoring device could be implemented through the use of the autonomous vehicle sensors and cameras fitted around the extremity of the vehicle.

An additional feature in practice of embodiments of the invention is that extended door opening travel is possible with a vehicle fitted with automated steering control. An example of this is autonomous vehicles that can, through their control system, ensure that the wheels are straightened prior to or during the door opening sequence. This allows for the doors to travel particularly close to the outer body of the vehicle and provide a significant increase in the opening envelope. This feature also better allows for independently functioning front and rear doors. The steering system can be locked in centre position whilst the door is in the fully open state. As an alternative the door rotary hinge mechanism can be modified to allow temporary displacement from the wheels impacting the door. This modification could include a spring element that attaches the door to the door actuation mechanism.

Powered operation of the mechanism is not limited to pneumatic action, and the actuators could alternatively be operated with a hydraulic fluid. As an additional alternative the actuators could be replaced with electrically operated devices such as a ball screw actuator and a harmonic drive based rotary joint. The disadvantage of such systems is that they require more sophisticated control systems but may remove the need for a compressed air system. Nonetheless, the pneumatic actuation system according to embodiments of the invention has certain advantages, such that it can easily be manually overridden in an emergency situation or where there is a system failure. Pneumatic systems are well known to provide consistent failure states or shut down states with limited increase to system complexity. When the system is in the depressurised state the door mechanism is able to be operated by hand with minimal effort and without risk of colliding with the exterior surface of the vehicle. This is particularly beneficial for implementation in autonomous vehicles, for example.

Although the description provided herein predominantly relates to a single door actuation mechanism fitted to a given vehicle door, it is also possible to have a secondary hinge and slide mechanism is attached to the door above or below to provide additional stiffness. Moreover, it is also possible for the mechanism to be distributed such that some components are located towards the top of the door and some components towards the bottom of the door.

In another embodiment, a two-stage locking device is provided that can be integrated onto the output shaft of the rotary actuator, for example. In embodiments, the locking device directly locks the rotation of the rotary actuator and in turn the motion control surface inherent in the design, thereby blocking linear motion of the mechanism in the closed position. In an embodiment of the lock device a spring is utilised to engage pawls of the lock and a small pneumatic piston provides the release mechanism. In this embodiment the locking device is normally latching, as is the case for a traditional vehicle door. An additional safety feature may be integrated into the locking device whereby a cable can be utilised to override the spring and release the lock. The cable can be manually operated. In addition, the pneumatic control of the lock device can be easily fitted with override functionality if so desired.

### BRIEF DESCRIPTION OF THE DRAWINGS

Further disclosure, objects, advantages and aspects of the present invention may be better understood by those skilled in the relevant art by reference to the following description of preferred embodiments taken in conjunction with the accompanying drawings, which are given by way of illustration only and thus not limitative of the present invention, and in which:

FIGS. 1A and 1B illustrate an example vehicle fitted with door actuation systems according to an embodiment of the invention—FIG. 1A shows the vehicle with doors closed and FIG. 1B shows the vehicle with doors open;

FIG. 2 is an inside perspective view of a vehicle door with a door actuation mechanism, isolated from the vehicle;

FIG. 3 is a perspective view of a vehicle door actuation mechanism according to an embodiment of the invention, in a partially deployed configuration and seen from the vehicle side of the mechanism;

FIG. 4 is a perspective view of a portion of the door actuation mechanism in a partially deployed configuration and seen from the door side of the mechanism;

FIG. 5 is a plan view of the door actuation mechanism as seen in FIG. 4;

FIGS. 6A-6E are plan views of the door actuation mechanism showing a sequence of stages between a closed configuration and a fully open configuration;

FIGS. 7A-7E are enlarged views corresponding to FIGS. 6A-6E;

FIG. 8 is a plan view of a latching mechanism; and

FIG. 9 is a simplified schematic diagram of a system incorporating a vehicle door actuation mechanism, according to an embodiment of the invention.

FIG. 10a is a perspective view of an autonomous roadway delivery vehicle having a plurality of vertically opening doors disposed along one side, each door including a door actuation mechanism shown in FIGS. 3 to 5.

FIG. 10b is a front perspective view of the autonomous roadway delivery vehicle shown in FIG. 10a.

FIG. 11 shows a perspective view of the plurality of vehicle door, isolated from the vehicle shown in FIG. 10.

FIG. 12 shows a reverse perspective view of the plurality of doors shown in FIG. 11.

FIG. 13 shows a perspective schematic view of a plurality of horizontally opening doors suitable for use with a vehicle.

FIG. 14 shows a reverse perspective view of the plurality of doors shown in FIG. 13

### DETAILED DESCRIPTION

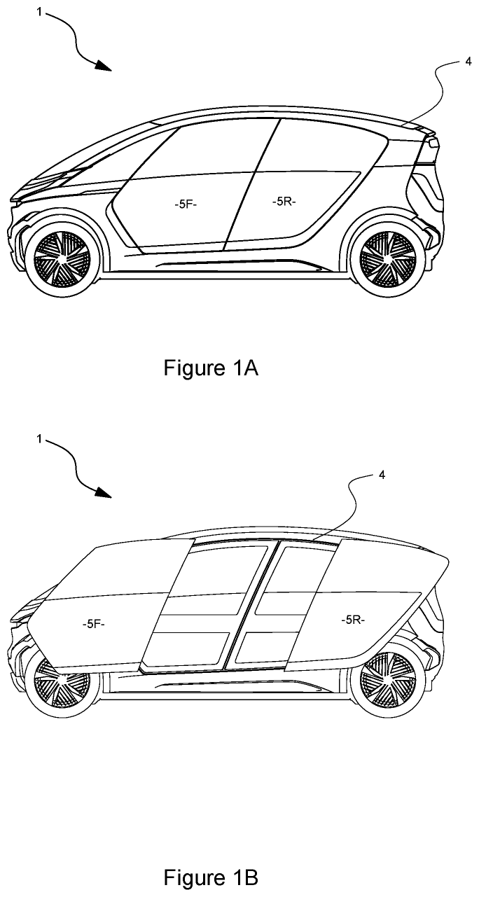

A vehicle door actuation mechanism 2 and system is disclosed herein with embodiments described in detail below with reference to FIGS. 1A to 9. FIGS. 1A and 1B show an example of vehicle 1 equipped with doors and door actuation mechanisms according to an embodiment of the invention. In this instance vehicle 1 is seen from the side which presents two (forward and rear) doors labelled 5F and 5R. FIG. 1A shows vehicle 1 with both doors 5F, 5R in their closed configurations, whereas FIG. 1B shows vehicle 1 with both doors 5F, 5R in their open configurations. As can be seen from a comparison of FIGS. 1A and 1B that, in an opening operation, the forward door 5F translates in the forward direction of vehicle 1 relative to vehicle body 4, while rear door 5R translates toward the back of vehicle 1. The door actuation mechanisms that allow the opening and closing action are not visible in FIG. 1.

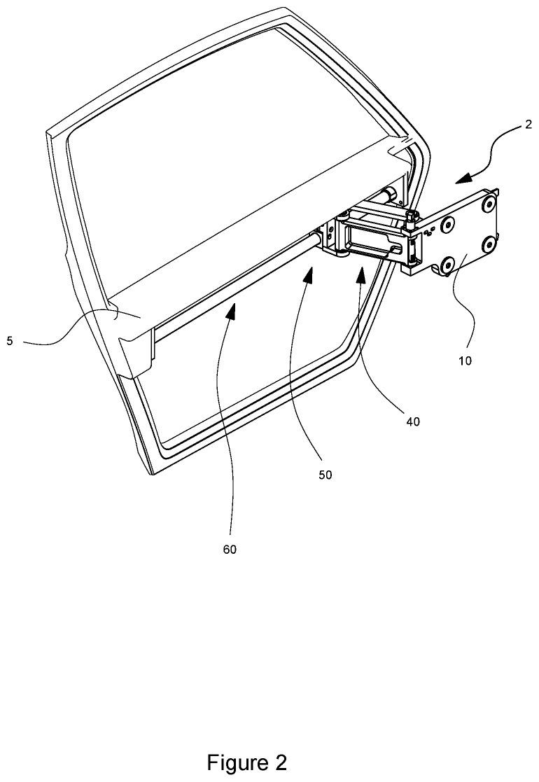

The vehicle door actuation mechanism can be seen in FIG. 2, for example, which shows door 5 from the inside aspect and with actuation mechanism 2 detached from the vehicle structure. As illustrated in the accompanying drawings actuation mechanism 2 has a vehicle mounting structure 10 adapted for mounting to a fixed structure of vehicle 1, such as the body, framework or chassis adjacent the door opening in the body of vehicle 1. Mounting structure 10 is in the form of a plate with apertures to accept fasteners for attaching to vehicle 1, although it will be appreciated that a plate-like formation is not necessary for attaching the mechanism to vehicle 1, and any appropriate mounting arrangement may be employed in practice. Various kinds of fasteners may be employed in attaching actuation mechanism 2 to the structure of vehicle 1, such as bolts, screws, rivets, adhesives, etc.

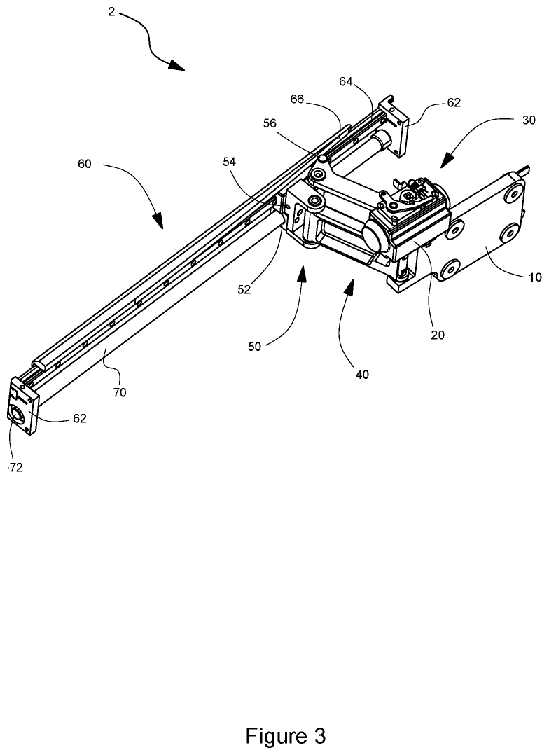

Rail assembly 60 is mounted to a door 5, as shown in FIG. 2. Rail assembly 60 has an elongate linear form that extends across the inside of door 5, typically in a substantially horizontal orientation. Rail assembly 60 is provided with means for mounting to the structure of door 5, such as end plates 62 as shown in FIG. 3, although any appropriate mounting arrangement may be employed in practice.

Swing arm assembly 40 and door support carriage 50 couple (interconnect) vehicle mounting structure 10 and rail assembly 60. Swing arm assembly 40 is pivotally supported by vehicle mounting structure 10 for pivotal motion about an axis transverse to the longitudinal extent of rail assembly 60, typically a substantially vertical axis as compared to the horizontally extending rail assembly 60. In the preferred embodiment the range of pivotal motion of the swing arm assembly 40 is approximately ninety degrees.

The distal end of swing arm assembly 40 carries door support carriage 50, also on a pivotal coupling. Rail assembly 60 engages with door support carriage 50 for sliding relative movement, whereby rail assembly 60 is able to slide such that door support carriage 50 traverses from substantially one end of rail assembly 60 to the other. Although in practice it is rail assembly 60 (which in use carries the vehicle door) that moves relative to support carriage 50 (attached to the swing arm assembly), for the purposes of explanation it is convenient in some instances herein to refer to support carriage 50 in terms of travelling along rail assembly 60.

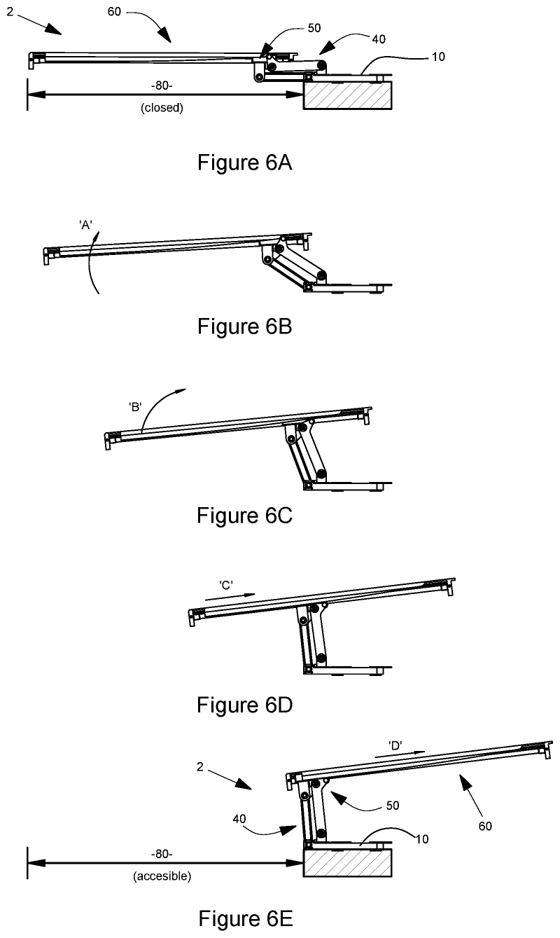

Linear motion of door support carriage 50 along rail assembly 60, and pivotal motion of swing arm assembly 40 on vehicle mounting structure 10, are both regulated by the design and arrangement of the door actuation mechanism 2, as described hereinbelow, to achieve a door opening and closing action that is illustrated in sequential stepwise manner in FIGS. 6A-6E. FIG. 6A shows door actuation mechanism 2 in a ‘closed’ configuration whereby a vehicle door (which would be attached to rail assembly 60) would in use cover an access opening 80 in the body of vehicle 1 to which vehicle mounting structure 10 is attached. For illustration structure 4 of the body of vehicle 1 and access opening 80 are indicated diagrammatically in FIGS. 6A and 6E. In the closed configuration of door actuation mechanism 2, door support carriage 50 is positioned to one end of rail assembly 60 and mounting structure 10, swing arm assembly 40 and rail assembly 60 are all substantially aligned with one another, in use extending longitudinally on one side of vehicle 1, for example. Rail assembly 60 is prevented from sliding movement on door support carriage 50 when in the closed configuration of door actuation mechanism 2.

During a door opening action of actuation mechanism 2, the first motion is pivoting of the swing arm assembly 40 on the mounting structure 10 whereby the rail assembly 60 (and thus door 5) moves out of alignment with mounting structure (away from the side of the vehicle), as indicated by arrow ‘A’ shown in FIG. 6B. Once the swing arm assembly 40 pivots to reach a certain angular orientation (e.g. as seen in FIG. 6C) the rail assembly is able to begin sliding on the door support carriage, with resulting combined motion of both the pivot and the slide indicated by arrow ‘B’. As the swing arm assembly approaches its final orientation (FIG. 6D), substantially perpendicular to its starting position, motion of the rail assembly is dominated by linear sliding as indicated by arrows ‘C’ and ‘D’ until the door support carriage is positioned at the opposite end of the rail assembly from which it began in the closed configuration. This is seen in FIG. 6E, which is the ‘open’ configuration of the door actuation mechanism.

Further details of the components and construction of the door actuation mechanism 2 according to an embodiment, which enables operation as outlined above, can be seen particularly in FIGS. 3, 4 and 5.

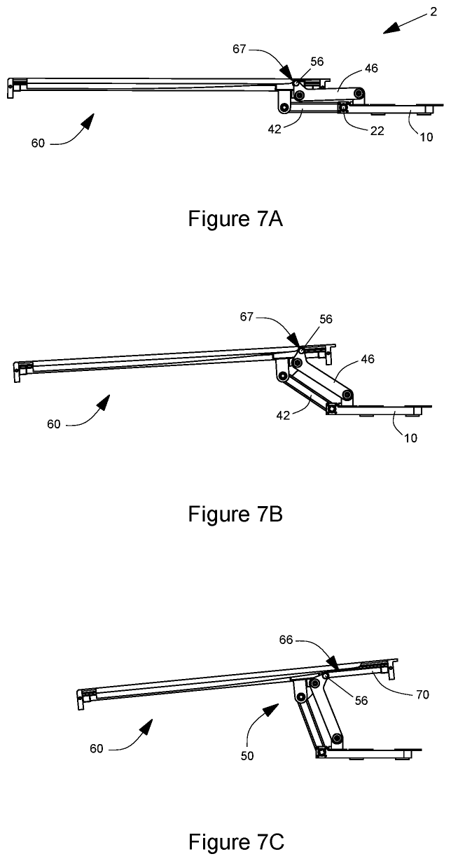

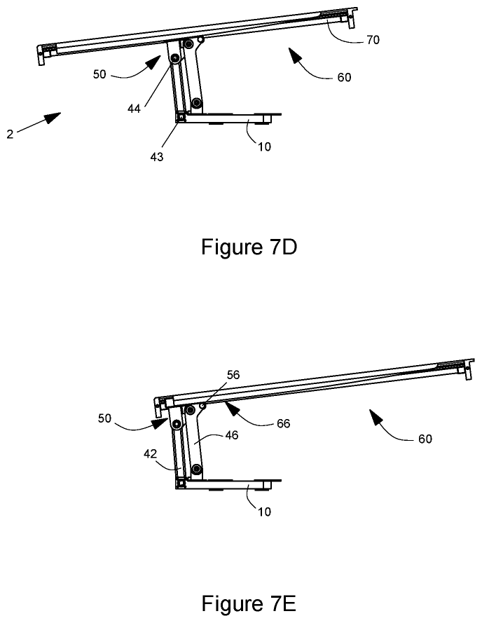

In the embodiment shown in FIGS. 7A to 7E swing arm assembly 40 includes inside and outside link members 42, 46 each coupled between vehicle mounting structure 10 and door support carriage 50 in the form of a near-parallel four-bar linkage. Specifically, the inside link member 42 is coupled to vehicle mounting structure at an inside link fixed pivot 43, and to door support carriage 50 at an inside link door pivot 44. Likewise, outside link member 46 is coupled to the vehicle mounting structure at an outside link fixed pivot 47, and to the door support carriage at an outside link door pivot 48. The inside and outside link fixed pivots 43, 47 have a fixed relationship to one another, as do the inside and outside link door pivots 44, 48, with axes slightly staggered with respect to the longitudinal line of the rail assembly to enable the link members to pivot into the closed configuration of the door actuation mechanism (e.g. as seen in FIG. 7A). The near-parallel linkage arrangement formed by the link members together with the mounting structure and door support carriage maintains rail assembly 60 in a (near-) parallel orientation while the swing arm pivots, although a slight angle is introduced (c.f. FIG. 6A and FIG. 6E) to ensure clearance between the vehicle door and body in use. The pivot couplings of link members 42, 46 to mounting structure 10 and support carriage 50 may be of any convenient form, comprising pins, bushings, bearings, etc.

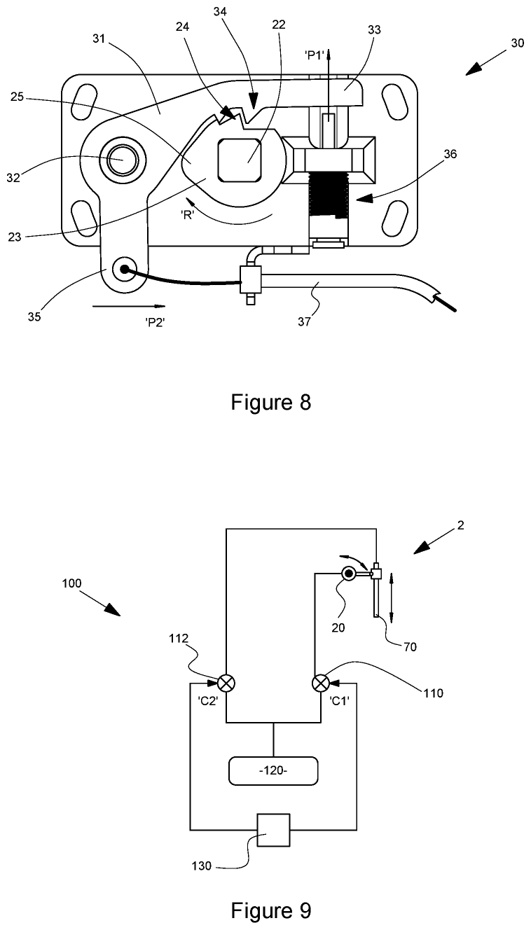

The inside link fixed pivot 43 is provided with a rotary actuation shaft 22 attached to the inside link member 42 for the purposes of automated or powered operation of the mechanism. In automated embodiments of door actuation mechanism 2 a rotary actuator, shown in FIG. 3 is coupled to drive shaft 22. For simplicity of illustration most of the drawings do not show the rotary actuator, except FIG. 3 where rotary actuator 20 is seen attached to mounting structure 10. Also seen in FIG. 3 is a latch mechanism 30 mounted atop rotary actuator 20, the working of which is described hereinbelow in connection with FIG. 8 which shows components of latch mechanism 30 in greater detail.

Rotary actuator 20 is capable of driving shaft 22, and thus swing arm assembly 40, selectively in a clockwise or counter clockwise direction with respect to mounting structure 10. In the embodiments as illustrated, rotation in the clockwise direction corresponds to a door opening action of the mechanism, whereas rotation in the counter clockwise direction corresponding to a door closing action. Nevertheless, it will be appreciated that this correspondence depends on the point of view, and whether the door actuation mechanism is arranged for a vehicle front door or rear door, on the left-hand or right-hand side.

Rotary actuator 20 may be of pneumatic operation (e.g. driven by pressurised air), although hydraulic or electric operated actuators may alternatively be used. In the embodiments as illustrated, however, use of a pneumatic actuator provides certain advantages as will be apparent from the description herein.

Rail assembly 60 comprises three main functional aspects for engaging with the door support carriage 50 and swing arm assembly 40.

An elongate linear motion guide track 64 extends substantially the length of the rail assembly and is provided to support the rail assembly (and thus the vehicle door, in use) by engagement with a linear motion track bearing 54 that comprises part of support carriage 50. This engagement permits linear sliding motion of the rail assembly relative to the door support carriage and may be implemented in many different ways but in this embodiment a hardened steel linear rail is used for track 64 and a recirculating ball cartridge unit for bearing 54.

A linear actuator 70 also extends along the length of rail assembly 60 and operates in a novel manner. Linear actuator 70 of the preferred embodiment is a pneumatically operated rod-less cylinder and comprises an elongate tube with respective pneumatic inputs 72, 74 at it ends. A piston (not seen in the drawings) is supported inside the tube, and the piston can be driven from one end to the other by application of pressurised air to the pneumatic inputs. The piston carries a magnet that is used to magnetically couple the piston with a magnet follower 52 that comprises part of support carriage 50. Magnet follower 52 fits closely about the outside of the linear actuator tube and contains a magnet or magnetically susceptible component that forms a magnetic attraction to the piston magnet. The magnetic coupling between the actuator piston and the magnet follower is used to transmit force from the linear actuator to the door support carriage such that, during operation of the linear actuator the piston inside the tube remains aligned with the door support carriage while the rest of the rail assembly (carrying the vehicle door, in use) travels in a linear path relative to door support carriage 50.

This provides a lightweight and compact linear actuator arrangement which advantageously can translate a relatively high proportion of the actuator's overall length. Moreover, the magnetic coupling of linear actuator 70 to door support carriage 50 provides an inherent safety feature wherein the force of magnetic coupling represents an absolute limit to the actuator force. In practical application on a vehicle door, for example, should a person's body part be trapped between the door and vehicle structure while the door actuation mechanism is closing, the transmitted force will be limited by the magnetic coupling between the rail assembly and the carriage, which force will be released once the magnetic coupling is overwhelmed and the piston becomes unaligned with the magnet follower.

Rail assembly 60 also includes a motion linear motion cam surface 66 which forms part of a motion control surface feature of the door actuation mechanism 2. Cam surface 66 is arranged to engage with cam follower 56 supported on a projecting portion of outside link member 46 and is contoured to effect control of relative linear and pivoting motions of the mechanism, as explained below. In particular, the contour of cam surface 66, the placement of cam follower 56 on swing arm assembly 40 and the engagement between cam follower 56 and cam surface 66 acts to restrict linear motion of rail assembly 60 until swing arm assembly 40 has reached a certain angular displacement, and restrict pivoting motion of swing arm assembly 40 over a range of linear displacement of the rail assembly.

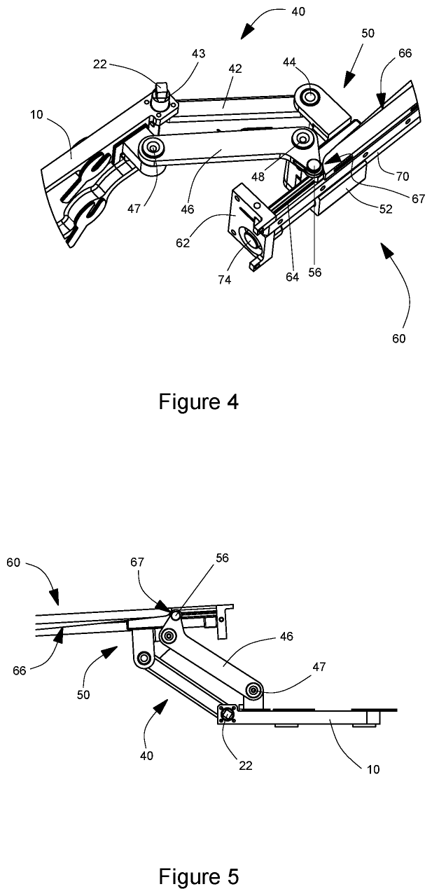

As seen in the drawings, cam surface 66 has a rounded shoulder 67 located at one end thereof, specifically at the end corresponding to the position of door support carriage 50 when door actuation mechanism 2 is in its ‘closed’ configuration. Referring to FIG. 7A, in this configuration cam follower 56 is engaged with cam shoulder 67, which prevents sliding motion of the rail assembly. As swing arm assembly 40 pivots towards the ‘open’ configuration (FIG. 4; FIG. 5; FIG. 7B) the angle of cam follower 56 in relation to cam surface 66 changes such that cam follower 56 traverses around shoulder 67. Once swing arm assembly 40 has rotated sufficiently (e.g. as seen in FIG. 7C) cam follower 56 traverses onto an adjoining sloped section of cam surface 66 which allows relative linear translation of rail assembly 60. Further rotation of swing arm assembly 40 places cam follower 56 in an angular orientation relative to cam surface 66 wherein linear motion of rail assembly 60 is unencumbered and can slide freely (FIGS. 7D and 7E). Thus, linear motion of rail assembly 60 in relation to support carriage 50 is regulated or restricted according to the angular orientation of swing arm assembly 40.

Conversely, angular movement of swing arm assembly 40 is also regulated (or restricted) according to the linear position of support carriage 50 along rail assembly 60, or more particularly according to the position of cam follower 56 along cam surface 66. For example, when rail assembly 60 is in the fully open configuration of the mechanism (e.g. as seen in FIG. 7E) swing arm assembly 40 is prevented from rotating counter-clockwise (as shown) toward the closed configuration because of engagement of cam follower 56 (attached to outside link member 46) with cam surface 66. It is not until rail assembly 60 slides toward the other end of its range, where cam surface 66 begins to taper toward shoulder 67, that pivoting motion of the swing arm assembly 40 can occur to a significant degree. Once cam follower 56 rounds the corner formed by shoulder 67 of cam surface 66, swing arm assembly 40 pivots to a more significant extent to the fully closed configuration.

Beneficially, the motion control surface arrangement of the mechanism, namely cam surface 66 along with pneumatic rotary and linear actuators 20, 70 enable simplified control systems to be implemented for opening and closing action. For example, a selected pneumatic pressure can be simultaneously applied to both the rotary and linear actuators 20, 70 and the sequencing of the motion (opening or closing) will be inherently controlled by the door mechanism and its motion control guide. If so desired, each actuator can be supplied with different pressures concurrently, through use of an additional pressure regulating device. In addition to the safety measure afforded by magnetic coupling, discussed above, safety of the system can further be ensured by maintaining a low differential pressure across linear actuator 70 until the door seal is required to be compressed, at which time additional force maybe required through application of increased pneumatic pressure.

For the purposes of securing door 5 when in the closed configuration, a latch mechanism (locking device) 30 is also provided to act in cooperation with door actuation mechanism 2. Latch mechanism 30 can be seen in FIG. 3, fitted on top of rotary actuator 20, and is shown in isolated plan view in FIG. 8. The principle of operation of latch mechanism 30 is to restrict or permit rotation of rotary actuation shaft 22, to which rotary actuator 20 is coupled to drive, in use. FIG. 8 shows latch mechanism 30 corresponding to a condition in which door actuation mechanism 2 is in a closed configuration and the door is latched shut.

Latch mechanism 30 comprises a latch ratchet member 23 that is affixed to turn with rotary actuation shaft 22. Latch ratchet member 23 has ratchet teeth 24 and a cam protrusion 25 formed on the outside edge thereof. Latch mechanism 30 also comprises a latch pawl member 31 that is pivotally mounted at pivotal mounting 32, adjacent to rotary actuation shaft 22. Latch pawl member 31 has pawl teeth 34 designed to engage with ratchet teeth 24, in use, and has first and second pawl pivot arms 33, 35. An automatic release actuator 36, which may be pneumatically driven or electrically operated for example, is mounted to act upon first pawl pivot arm 33 in a direction indicated by arrow ‘P1’, resulting in anticlockwise pivoting motion of pawl member 31 about pivotal mounting 32. Manual release actuator 37, in the form of a Bowden cable for example, is coupled to act on second pawl pivot arm 35 in a direction indicated by arrow ‘P2’, also resulting in anticlockwise pivoting motion of pawl member 31. Pawl member 31 may be biased in a clockwise direction by means of a spring or the like in order to maintain a latched state in the absence of external input.

As noted above, latch mechanism 30 as seen in FIG. 8 corresponds to a condition in which the door actuation mechanism is in a closed configuration and the door is latched shut. In this state latch mechanism 30 is effective to prevent clockwise rotation of rotary actuation shaft 22 by engagement between ratchet teeth 24 and pawl teeth 34. In automatic operation of door actuation mechanism 2, latch mechanism 30 is driven into an unlatched state by automatic release actuator 36, in coordination with rotary and linear actuators 20, 70. This causes pawl teeth 34 to disengage from ratchet teeth 24 and allow rotary actuation shaft 22 to be driven in the clockwise direction (i.e. as indicated by arrow ‘R’) through the approximately ninety-degrees of travel necessary for door mechanism 2 to reach its fully open configuration. Once shaft 22 and ratchet member 23 begin rotation, pawl member 31 is engaged by cam protrusion 25 which maintains pawl teeth 34 separated from ratchet teeth 24. Upon door 5 closing, pawl teeth 34 automatically re-engage with ratchet teeth 24 by virtue of spring bias applied to pawl member 31.

Should automatic release actuator 36 fail or malfunction or it becomes otherwise necessary to open door 5 manually, manual release actuator 37 can be used to drive latch mechanism 30 into its unlatched state. For example, the cable of manual release actuator 37 may be coupled to a user operable handle (not shown) or the like, accessible from inside and/or outside vehicle 1, which may be pulled so as to operate pawl member 31 by pulling on second pawl pivot arm 35.

A vehicle door opening/closing system 100 is shown in a simplified schematic diagram in FIG. 9, incorporating actuation mechanism 2 as described hereinabove. Door actuation mechanism 2 has rotary actuator 20 and linear actuator 70 which are pneumatically operated by way of respective control valves 110 and 112. Valves 110, 112 regulate the flow of pressurised gas from a pneumatic gas source 120 to rotary and linear actuators 20, 70. The valves 110, 112 are controlled by respective control signals ‘C1’ and ‘C2’ in use provided by control processor 130. Those of ordinary skill in the art will recognise that the FIG. 9 diagram is simplified at least insofar as only a single control valve 110, 120 is shown for each respective actuator 20, 70, whereas at least two controllable valve may be necessary to account for both opening and closing operations of the door mechanism. For example, in practice each of the valves 110, 112 may comprise a pneumatic five-way, three-position (“5/3”) valve, the implementation of which will be readily understood by those skilled in the art. Due to construction of door mechanism as described herein it is possible to use a single “5/3” valve per door, with the rotary actuator and the linear actuator connected in parallel. The sequencing of the motion is controlled by the “motion control surface”. In addition to four “5/3” valves (one for each door) the vehicle preferably includes an on-board electric compressor, a storage tank and a pressure regulator (together indicated collectively as pneumatic gas source 120 in FIG. 9).

It may be appreciated from the foregoing description that one benefit of the vehicle door actuation mechanism according to embodiments of the invention is that a simple and fail-safe control system may be utilised. Because the sequencing of rotating and sliding movements of the door mechanism are governed by the structure of the mechanism itself, for fully automated operation it is not necessary for the control system to control the timing of signals (e.g. ‘C1’ and ‘C2’) to operate the rotary and linear actuators. This is further facilitated by the use of pneumatic actuators which are relatively forgiving in instances of static actuation. For example, were an electric actuator to be energised and then held stationary there is a likelihood of damage to the device (e.g. overheating coils or the like), whereas a pneumatic actuator can typically deal with such an event without undue difficulty. In the present application this means that both the rotary and linear actuators can be energised at the same time, even though one of them must remain largely stationary for a period of time, until the arrangement of the mechanism allows it to move.

The above notwithstanding, embodiments of the present invention also allow for the system to operate semi-manually, where the separate actuators are energised individually or in sequential manner. For example, there may be circumstances in which it is desirable for the initial opening or final closing ‘swinging’ motion of the vehicle door is completed manually, whilst the sliding action is performed automatically. The door actuation mechanism as disclosed herein allows for such operation. Moreover, should the system lose air pressure for some reason the pneumatic actuators will generally allow for fully manual operation of the vehicle door, such that the system may be considered fail-safe.

The abovementioned vehicle door actuation mechanism 2 and system as described in FIGS. 1A to 9, is particularly advantageous because it can be used in multi-door vehicles where there exist to two or more doors adjacent to each other, in close proximity on the same side of the vehicle.

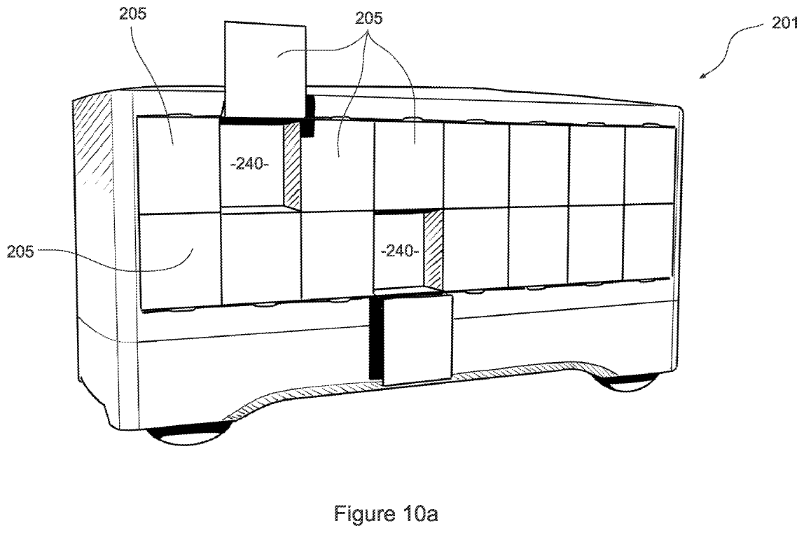

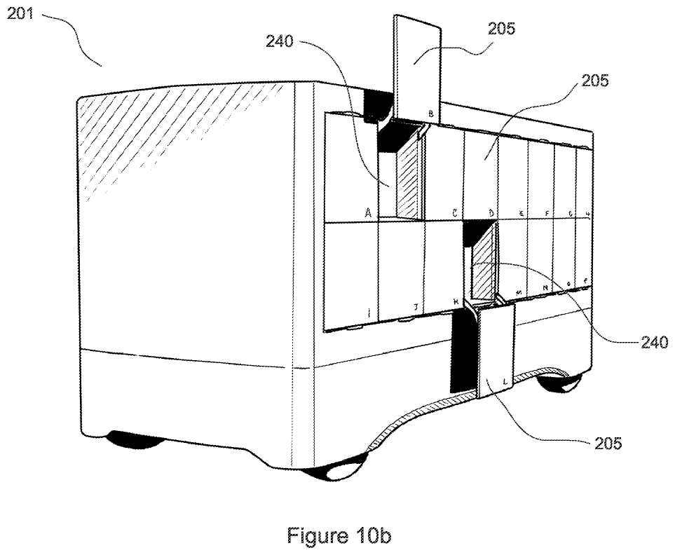

An embodiment of a vehicle 201 having a plurality of vertically opening doors 205 is shown in FIGS. 10a to 12. In this embodiment vehicle 201 is an “autonomous roadway delivery vehicle” for delivering cargo. Vehicle 201 has sixteen doors 205, arranged in two rows, namely an upper row and a lower row.

Each row comprises eight “doors side by side”, in close proximity to each other. In this specification “close proximity” means there is minimal spacing between each door 205. There is also “close proximity” of doors 205 in the upper row to the respective doors 205 in the lower row. In FIG. 10b, the eight doors 205, in the upper row are labelled A-H, and the eight doors in the bottom row are labelled I to P. The doors 205 labelled B and L are shown in open configuration.

Each door 205 has an actuation mechanism 202 which is identical to door actuation mechanism 2 of the earlier described embodiments. Each door 205 covers a respective “access aperture” 240 in vehicle 201.

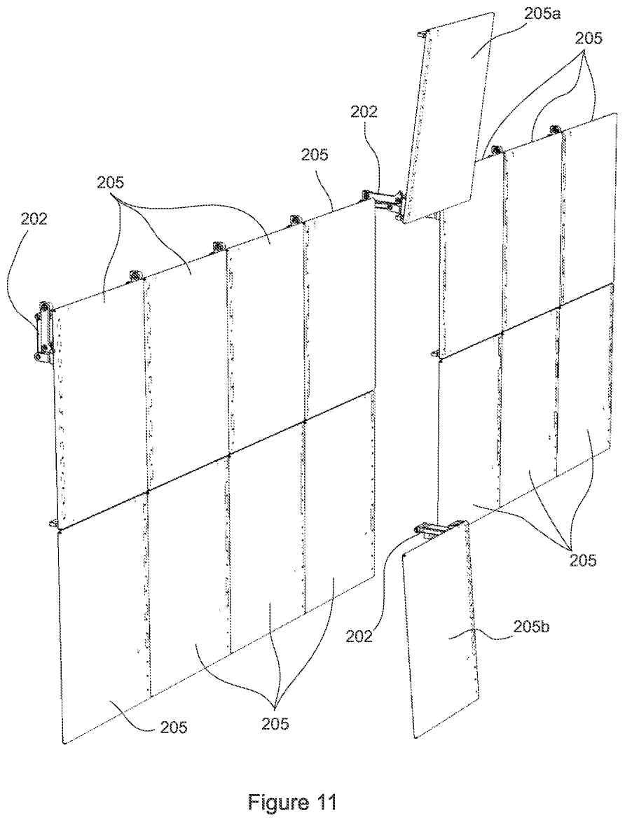

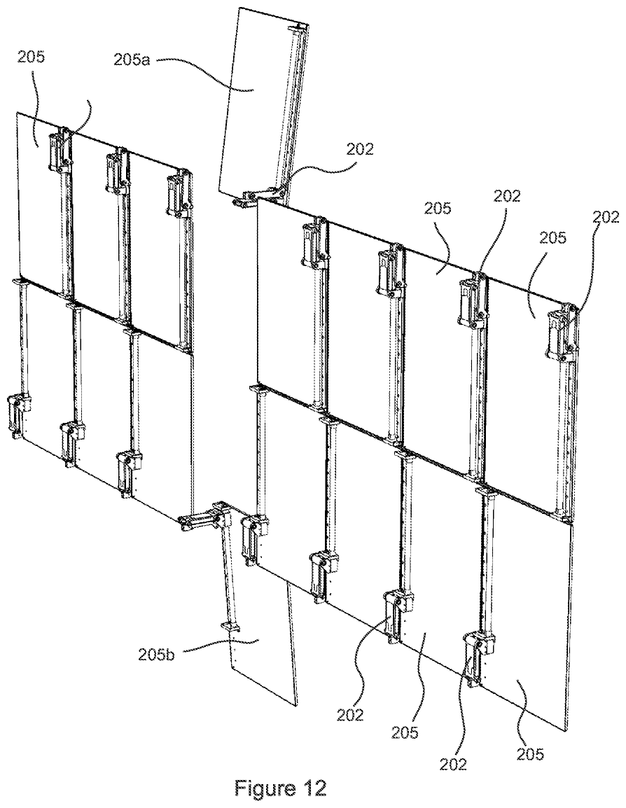

For ease of reference and clarity, FIGS. 11 and 12 show doors 205 without the vehicle body structure. In FIG. 11, door 205a (which is identified as door E in FIG. 10a) is shown “vertically” opening in an upwards movement by means of its respective door actuation mechanism 202. Likewise, door 205b (which is identified as door M in FIG. 10a) is shown “vertically” opening downwardly by means of its respective door actuation mechanism 202. The term “vertically” is used because when the doors 205a and 205b have opened, they have moved vertically relative to their closed position.

As seen in FIG. 12, door actuation mechanisms 202 are disposed on the inside of doors 205. It can be appreciated that during movement of doors 205a and 205b to their open positions, their respective door actuation mechanisms 202 are clear of the surrounding doors 205 and other door actuation mechanisms 202.

In FIGS. 11 and 12, doors 205a and 205b are actuated by respective door mechanisms 202 so that door 205a has moved upwardly, and door 205b has moved downwardly. This is because the door mechanism 202 associated with door 205a is at the top of that door, and because the door mechanism 202 associated with door 205b is at the bottom of that door.

However, it should be understood that in an alternative not shown embodiment, if the door mechanism 202 associated with door 205a was inverted and relocated so it was at the bottom of that door, then door 205a would open downwardly, and overlap door 205b when the latter is in a closed configuration. Likewise, in an alternative not shown embodiment, if the door mechanism 202 associated with door 205b was inverted and relocated so it was at the top of that door, then door 205b would open upwardly, and overlap door 205a when the latter is in a closed configuration.

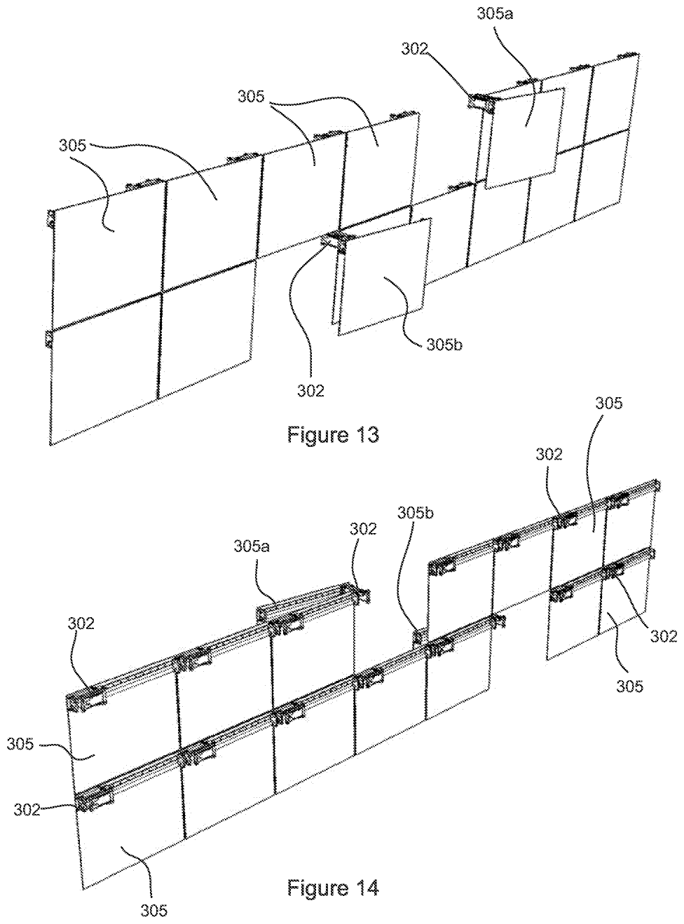

The multi-door vehicle of the present invention employing door actuation mechanisms 2 similar to that described in FIGS. 3, 4 and 5, is not restricted to “vertically” opening doors as described in FIGS. 10 to 12. An alternative embodiment is shown in FIGS. 13 and 14, where there is a plurality of “horizontally” opening doors 305.

Sixteen doors 305, are arranged in two rows, namely an upper row of eight doors and a lower row of eight doors. Each of doors 305 is in close proximity to other doors adjacent to it in the same row, and to a number of doors in the adjacent row. Each door 305 has an actuation mechanism 302 which is identical to door actuation mechanism 2 of the earlier described embodiment. These doors 305 could be used to cover access apertures in a not shown vehicle.

In FIG. 13, door 305a in the upper row is shown “horizontally” opened in a transverse movement by means of its respective door actuation mechanism 302. Likewise, door 305b in the lower row is shown “horizontally” opened by means of its respective door actuation mechanism 302. The term “horizontally” is used because the when the doors 305a and 305b have opened, they have moved horizontally relative to their closed position but stay aligned with their particular row of doors. What should be noted is that both doors 305a and 305b when in an open configuration, overlap one of its adjacent doors in the same row.

As seen in FIG. 14, door actuation mechanisms 302 are disposed on the inside of doors 305, and it can be appreciated that during movement of doors 305a and 305b to their open positions, their respective door actuation mechanisms 302 are clear of the surrounding doors 305 and other door actuation mechanisms 302.

What is important to note about the multi-door arrangements shown in FIGS. 10a to 14, is that door actuation mechanisms 202, 302 allow for their respective doors 205, 305 to open, even though such multi-doors are in close proximity to each other both in side by side relationship, or one above the other.

What should be understood is that whilst the abovementioned embodiments in FIGS. 10a-14 are directed to multi-doors for use with an autonomous roadway delivery vehicle, the multi-door arrangement could be employed on conventional roadway vehicles and vehicle trailers.

Multi-door arrangements as shown in FIGS. 10a-14 employing door mechanisms 202, 302 allow for adjacent doors to be simultaneously actuated. For example, one door during actuation could be travelling towards its closed configuration, whilst an adjacent door has commenced actuation to open.

What should be understood is that the latch mechanism (locking device) 30 that cooperates with door actuation mechanism 2 as described earlier with reference to FIG. 8, could be used with the multi-doors and their door mechanisms 202, 302 of FIGS. 10a-14. Likewise, the secondary lock arrangement (pneumatic or electric) as depicted in FIG. 9 and incorporating door actuation mechanism 2, could also be used in the door mechanisms 202, 302 of the multi-door arrangements.

The structure and implementation of embodiments of the invention has been described by way of non-limiting example only, and many additional modifications and variations may be apparent to those skilled in the relevant art without departing from the spirit and scope of the invention described.

Any discussion of documents, devices, acts or knowledge in this specification is included to explain the context of the invention. It should not be taken as an admission that any of the material forms part of the prior art base or common general knowledge in the relevant art in Australia or elsewhere on or before the priority date of the disclosure and claims herein.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A mechanism to enable opening and closing of a vehicle door comprising:
a swing arm assembly in use pivotally coupled between a vehicle structure and a slide support carriage;
said slide support carriage being mounted to an elongate rail assembly attached to said vehicle door for movement there along;
wherein said mechanism further comprises a motion control surface attached to or integral with said door assembly and a follower assembly to regulate relative simultaneous pivotal motion of said swing arm according to the position and motion of said slide support carriage along said rail assembly, and a pneumatically operated rotary actuator arranged to drive pivotal motion of said swing arm assembly, and pneumatically operated a linear actuator arranged to drive relative linear motion between said rail assembly and said slide support carriage.

2. A mechanism as claimed in claim 1, wherein said pneumatically actuated rotary actuator is attached to the vehicle mounting structure of said mechanism.

3. A mechanism as claimed in claim 2, wherein said linear actuator comprises a rod-less cylinder forming part of said elongate rail assembly, together with a magnetically coupled follower incorporated into said slide support carriage.

4. A mechanism as claimed in claim 1, wherein said motion control surface and said follower assembly regulate said position of said slide support along said rail assembly according to the pivotal movement of said swing arm according to the shape of said motion control surface.

5. A mechanism as claimed in claim 1, wherein said vehicle comprises a plurality of wheels operably controlled by an automated steering control system, and prior to or during a door opening sequence, said wheels are straightened by said automated steering control system.

6. A mechanism as claimed in claim 2, wherein said mechanism comprises a two-stage locking device that directly locks said rotary actuator and blocks linear motion of said linear actuator when said vehicle door is in a closed position.

7. A system for use in opening and closing a vehicle door comprising:
a door actuation mechanism including:
a swing arm assembly pivotally coupled between a vehicle structure and a slide support carriage;
said slide support carriage being mounted to an elongate rail assembly attached to said vehicle door for movement there along; and
wherein said mechanism further includes a motion control surface attached to or integral with said door assembly and a follower assembly to regulate relative pivotal motion of said swing arm according to the position and motion of said slide support carriage along said rail assembly according to the shape of said motion control surface;
a first pneumatic actuator coupled to drive pivotal motion of said swing arm assembly;
a second pneumatic actuator coupled to drive linear motion of said rail assembly relative to the slide support carriage; and
a control means arranged to operate said first and second pneumatic actuators simultaneously.

8. A system as claimed in claim 7, wherein said rotary actuator is attached to the vehicle mounting structure of said mechanism.

9. A system as claimed in claim 7, wherein said second pneumatic actuator comprises a rod-less cylinder forming part of said elongate rail assembly, together with a magnetically coupled follower incorporated into said slide support carriage.

10. A door assembly for a vehicle having a structure defining an access aperture, said door assembly comprising:
a door movable between a closed position covering at least a portion of said aperture and an open position substantially clearing at least said portion of said aperture;
a door actuation mechanism coupling said door to said structure, said door actuation mechanism including:
a swing arm assembly mounted to said structure adjacent said aperture and pivotally coupled to a slide support carriage, said slide support carriage mounted to an elongate rail assembly attached to said door for movement there along, wherein said door actuation mechanism includes a motion control surface to regulate simultaneous pivotal motion of said swing arm according to the position and motion of said slide support carriage along said rail assembly;
a first pneumatic actuator coupled to drive pivotal motion of said swing arm assembly;
a second pneumatic actuator coupled to drive linear motion of said rail assembly relative to said slide support carriage; and
a control means arranged to operate said first and second pneumatic actuators.

11. A door assembly as claimed in claim 10, wherein said first pneumatic actuator is attached to the vehicle mounting structure of said mechanism.

12. A roadway vehicle comprising:
a vehicle body structure defining an access aperture;
a door assembly including a door movable between a closed position covering at least a portion of said aperture and an open position substantially clearing at least said portion of the aperture;
a door actuation mechanism coupling said door to said vehicle body structure, said door actuation mechanism including:
a swing arm assembly mounted to said vehicle body structure adjacent said aperture and pivotally coupled to a slide support carriage, said slide support carriage being mounted to an elongate rail assembly attached to said door for movement there along, wherein said door actuation mechanism includes a motion control surface attached to integral with said door assembly and a follower assembly to regulate relative pivotal motion of said swing arm according to the position and motion of said slide support carriage along said rail assembly;
a first pneumatic actuator coupled to drive pivotal motion of said swing arm assembly;
a second pneumatic actuator coupled to drive linear motion of said rail assembly relative to said slide support carriage; and
a control means arranged to operate said first and second pneumatic actuators simultaneously.

13. A roadway vehicle as claimed in claim 12, wherein said first pneumatic actuator is attached to the vehicle mounting structure of said mechanism.

14. A roadway vehicle comprising:
a vehicle body structure defining at least first and second access apertures, said first and second access apertures being adjacent to each other on the same side of said vehicle body structure;
each of said first and second access apertures having a respective first and second door assembly;
said first door assembly including a first door movable between a closed position covering at least a portion of said first access aperture and an open position substantially clearing at least said portion of said first access aperture;
a door actuation mechanism coupling said first door to said vehicle body structure, said door actuation mechanism including:
a swing arm assembly mounted to said vehicle body structure adjacent said first access aperture and pivotally coupled to a slide support carriage, said slide support carriage being mounted to an elongate rail assembly attached to said first door for movement there along, wherein said door actuation mechanism includes a motion control surface attached to integral with said first door assembly and a follower assembly to regulate relative pivotal motion of said swing arm according to the position and motion of said slide support carriage along said rail assembly;
a first pneumatic actuator coupled to drive pivotal motion of said swing arm assembly;
a second pneumatic actuator coupled to drive linear motion of said rail assembly relative to said slide support carriage; and
a control means arranged to operate said first and second pneumatic actuators simultaneously.

15. A roadway vehicle as claimed in claim 14, wherein said second pneumatic actuator, comprises a rod-less cylinder forming part of said elongate rail assembly, together with a magnetically coupled follower incorporated into said slide support carriage.

16. A roadway vehicle as claimed in claim 14, wherein said second door assembly including a second door movable between a closed position covering at least a portion of said second access aperture and an open position substantially clearing at least said portion of said second access aperture is disposed adjacent the first access aperture, and said second door is coupled to said vehicle body structure with a like actuation mechanism to that of said first door.

17. A roadway vehicle as claimed in claim 14, wherein said roadway vehicle is a cargo delivery vehicle.

18. A roadway vehicle as claimed in claim 14, wherein said roadway vehicle is an autonomous vehicle.

19. A roadway vehicle as claimed in claim 14, wherein said first and second access apertures are side by side to each other.

20. A roadway vehicle as claimed in claim 14, wherein said first and second access apertures are disposed one of above the other.

21. A roadway vehicle as claimed in claim 14, wherein said vehicle comprises a plurality of wheels operably controlled by an automated steering control system, and prior to or during a door opening sequence, said wheels are straightened by said automated steering control system.
